(19) United States
(12) Patent Application Publication
(10) Pub. No.: US 2020/0272274 A1
(43) Pub. Date: Aug. 27, 2020

(54) TERMINAL DEVICE INTERACTION METHOD, STORAGE MEDIUM AND TERMINAL DEVICE

(71) Applicant: HuiZhou TCL Mobile Communication Co., Ltd., HuiZhou (CN)

(72) Inventors: Yulin LI, HuiZhou (CN); Xin ZHENG, HuiZhou (CN); Ling YU, HuiZhou (CN); Qundian CHEN, HuiZhou (CN)

(73) Assignee: HuiZhou TCL Mobile Communication Co., Ltd., HuiZhou (CN)

(21) Appl. No.: 16/647,510

(22) PCT Filed: Sep. 14, 2018
(86) PCT No.: PCT/CN2018/105833

§ 371 Date: Mar. 15, 2020

(30) Foreign Application Priority Data
Sep. 15, 2017 (CN) 201710835114.1

(51) Int. Cl. G06F 3/041; H04M 1/02; G06F 3/0488; G06K 9/00; G06F 21/32

(52) U.S. Cl. CPC G06F 3/0416; H04M 1/0266; G06F 21/32; G06K 9/0002; G06F 3/04883

(57) ABSTRACT

Disclosed are a terminal device interaction method, a storage medium and a terminal device. The terminal device comprises a processor, a fingerprint module, and a touch screen arranged around the fingerprint module. The fingerprint module is used for recognizing user fingerprint information, the touch screen is used for recognizing user touch information, and the processor is used for determining, when receiving the fingerprint information and the touch information, a sliding direction of an input for the fingerprint module according to the fingerprint information and the touch information, and executing an interaction operation corresponding to the sliding direction.

### CROSS REFERENCE

This application claims the priority of Chinese Patent Application No. 201710835114.1, entitled “TERMINAL DEVICE INTERACTION METHOD, STORAGE MEDIUM AND TERMINAL DEVICE”, filed on Sep. 15, 2017, the disclosure of which is incorporated herein by reference in its entirety.

### FIELD OF THE INVENTION

The present application relates to the field of smart terminal, more particularly, to an interaction method of a terminal device, a storage medium and a terminal device.

### BACKGROUND

With the continuous development of the Internet and the popularity of mobile terminals, mobile terminals have been widely used in people's lives. In addition, when the mobile terminal is in the screen lock state, at least two steps are required for a user to open an application, which are unlocking and opening the application, respectively. In mobile phone products equipped with fingerprint unlocking, users also need to perform the laborious process that includes using the fingerprints to unlock the mobile phones first and then opening the applications. Not only does it take a long time to open the applications, but inconvenience is also caused to the users.

Therefore, there is a need to improve the related art.

### SUMMARY

The embodiment according to the present application provides an interaction method of a terminal device, a storage medium and a terminal device, which enables the user to quickly interact with the terminal device when the terminal device is in a screen lock state.

One aspect of the embodiment of the present application provides a terminal device. The terminal device comprises a processor, a fingerprint module and a touch screen disposed around the fingerprint module. The fingerprint module is configured to identify user's fingerprint information. The touch screen is configured to identify user's touch information. The processor is configured to determine a sliding direction input to the fingerprint module based on fingerprint information and touch information when the fingerprint information and the touch information are received, and execute an interaction operation corresponding to the sliding direction.

In the terminal device, the processor is further configured to discard the touch information when only receiving the touch information within a predetermined time.

In the terminal device, the fingerprint module is embedded in the touch screen to form an integrated structure, the touch screen is disposed and extends along a circumferential direction of the fingerprint module.

In the terminal device, the fingerprint module and the touch screen adopt a same connector to be connected to the processor, so that all signals output by the fingerprint module and all signals output by the touch screen interact with the processor through the same connector.

In the terminal device, the touch screen comprises a fingerprint touch screen and a display touch screen;

the fingerprint touch screen being configured to cooperate with the fingerprint module to identify the sliding direction input by the fingerprint module, wherein the fingerprint touch screen is in a usable state only when the terminal device is in a screen lock state;

the display touch screen being configured for touch input and image display.

In the terminal device, the fingerprint module is integrated on the touch screen, the touch screen covers the fingerprint module, and the touch screen has an area larger than a fingerprint identification area of the fingerprint module.

In the terminal device, the touch screen comprises integrating a fingerprint identification region of the fingerprint module and a locus identification region in a periphery of the fingerprint module, the fingerprint identification region and the locus identification region constitute a sensing region of the touch screen.

Another aspect of the embodiment of the present application provides an interaction method of a terminal device applied to the terminal device. The terminal device comprises a processor, a fingerprint module and a touch screen disposed around the fingerprint module. The fingerprint module is configured to identify user's fingerprint information. The touch screen is configured to identify user's touch information. The processor is configured to determine a sliding direction input to the fingerprint module based on fingerprint information and touch information when the fingerprint information and the touch information are received, and execute an interaction operation corresponding to the sliding direction. The interaction method comprises:

obtaining the fingerprint information input at the fingerprint module and the touch information input on the touch screen when the terminal device is in a screen lock state;

determining the sliding direction input by the fingerprint module according to the touch information; and

starting the interaction operation corresponding to the sliding direction when the fingerprint information satisfies an unlocking requirement.

According to the interaction method, obtaining the fingerprint information input at the fingerprint module and the touch information input on the touch screen when the terminal device is in the screen lock state comprises:

monitoring the fingerprint information input at the fingerprint module and the touch information input on the touch screen when the terminal device is in the screen lock state;

detecting whether a second type of control information is received or not within a predetermined time after a first type of control information is monitored, wherein the first type of control information is the fingerprint information/touch information, the second type of control information is the touch information/fingerprint information; and

executing a step of determining the sliding direction input by the fingerprint module if the second type of control information is detected.

According to the interaction method, obtaining the fingerprint information input at the fingerprint module and the touch information input on the touch screen when the terminal device is in the screen lock state further comprises:

determining a type of the first type of control information if the second type of control information is not detected, wherein the first type of control information comprises the fingerprint information and the touch information;

unlocking the terminal device when the first type of control information is the fingerprint information; and

discarding the touch information when the first type of control information is the touch information.

According to the interaction method, the sliding direction is a direction from the touch screen to the fingerprint module or a direction from the fingerprint module to the touch screen.

According to the interaction method, before obtaining the fingerprint information input at the fingerprint module and the touch information input on the touch screen when the terminal device is in the screen lock state, the interaction method further comprises:

establishing a database in advance, the database being configured to store a corresponding relationship between the sliding direction and the interaction operation, wherein sliding directions correspond to interaction operations one on one.

According to the interaction method, determining the sliding direction input by the fingerprint module according to the touch information comprises:

obtaining a touch point closest to the fingerprint module in the touch information; and

determining the sliding direction input by the fingerprint module according to a position relationship between the touch point and a center position of the fingerprint module.

Still another aspect of the embodiment of the present application provides a storage medium storing a plurality of instructions. The instructions are adapted to be loaded and executed by a processor to execute the operations of:

obtaining fingerprint information input at a fingerprint module and touch information input on a touch screen when a terminal device is in a screen lock state, and recording an acquisition time of the fingerprint information and a collection time of the touch information;

determining a sliding direction input by the fingerprint module based on the touch information, the acquisition time of the fingerprint information and the collection time of the touch information; and

starting an interaction operation corresponding to the sliding direction when the fingerprint information satisfies an unlocking requirement.

According to the storage medium, obtaining the fingerprint information input at the fingerprint module and the touch information input on the touch screen when the terminal device is in the screen lock state comprises:

monitoring the fingerprint information input at the fingerprint module and the touch information input on the touch screen when the terminal device is in the screen lock state;

detecting whether a second type of control information is received or not within a predetermined time after a first type of control information is monitored, wherein the first type of control information is the fingerprint information/touch information, the second type of control information is the touch information/fingerprint information; and

executing an operation of determining the sliding direction input by the fingerprint module if the second type of control information is detected.

According to the storage medium, obtaining the fingerprint information input at the fingerprint module and the touch information input on the touch screen when the terminal device is in the screen lock state further comprises:

determining a type of the first type of control information if the second type of control information is not detected, wherein the first type of control information comprises the fingerprint information and the touch information;

unlocking the terminal device when the first type of control information is the fingerprint information; and

discarding the touch information when the first type of control information is the touch information.

According to the storage medium, the sliding direction is a direction from the touch screen to the fingerprint module or a direction from the fingerprint module to the touch screen.

According to the storage medium, before obtaining the fingerprint information input at the fingerprint module and the touch information input on the touch screen when the terminal device is in the screen lock state, the interaction method further comprises:

establishing a database in advance, the database being configured to store a corresponding relationship between the sliding direction and the interaction operation, wherein sliding directions correspond to interaction operations one on one.

According to the storage medium, the operation of determining the sliding direction input by the fingerprint module based on the touch information, the acquisition time of the fingerprint information and the collection time of the touch information comprises:

obtaining a touch point closest to the fingerprint module in the touch information based on the touch information, the acquisition time of the fingerprint information and the collection time of the touch information; and

determining the sliding direction input by the fingerprint module according to a position relationship between the touch point and a center position of the fingerprint module.

According to the storage medium, the collection time of the touch information refers to a touch time of each of touch points included in the recorded touch information, the operation of obtaining the touch point closest to the fingerprint module in the touch information based on the touch information, the acquisition time of the fingerprint information and the collection time of the touch information comprises:

determining the touch point closest to the fingerprint information in terms of time in the touch information based on the touch time corresponding to each of the touch points included in the touch information and the acquisition time corresponding to the fingerprint information.

As compared with the related art, the present application provides an interaction method of a terminal device, a storage medium and a terminal device. The terminal device comprises a processor, a fingerprint module and a touch screen disposed around the fingerprint module. The fingerprint module is configured to identify user's fingerprint information. The touch screen is configured to identify user's touch information. The processor is configured to determine a sliding direction input to the fingerprint module based on fingerprint information and touch information when the fingerprint information and the touch information are received, and execute an interaction operation corresponding to the sliding direction. According to the present application, through adding the touch screen on the outside of the fingerprint module, identifying the sliding direction input to the fingerprint module by using the touch screen and the fingerprint module, and executing the interaction operation corresponding to the sliding direction, the user can quickly interact with the terminal device when the terminal device is in the screen lock state.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a structure of a terminal device according to a preferred embodiment of the present application.

FIG. 2 is a schematic diagram of a sensing region of a terminal device according to one embodiment of the present application.

FIG. 3 is a flowchart of an interaction method of a terminal device according to a preferred embodiment of the present application.

FIG. 4 to FIG. 8 are schematic diagrams of sliding directions in an interaction method of a terminal device according to embodiments of the present application.

FIG. 9 is a schematic diagram of a structure of a mobile terminal according to one embodiment of the present application.

### DESCRIPTION OF THE EMBODIMENTS

The present disclosure a gamepad, a related control method and storage medium. These and other features, aspects and advantages of the present disclosure will become understood with reference to the following description, appended claims and accompanying figures.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the inventive concept.” It will be understood that when an element or layer is referred to as being “on”, “connected to”, “coupled to”, or “adjacent to” another element or layer, it can be directly on, connected to, coupled to, or adjacent to the other element or layer, or one or more intervening elements or layers may be present. When an element or layer is referred to as being “directly on,” “directly connected to”, “directly coupled to”, or “immediately adjacent to” another element or layer, there are no intervening elements or layers present.

Any process or method described in the flowchart or otherwise described herein may be understood to include one or more modules, fragments, or portions of code of an executable instruction to implement a particular logical function or process. In addition, the scope of at least one embodiment of the present disclosure includes additional implementations in which the functions may be performed in a sequence that is not shown or discussed, including in a substantially simultaneous manner or in the reverse order depending on the function involved, which is understood by those skilled in the art to which this present disclosure pertains.

The invention is described below in detail with reference to the accompanying drawings, in which exemplary embodiments of the invention are shown.

### Embodiment 1

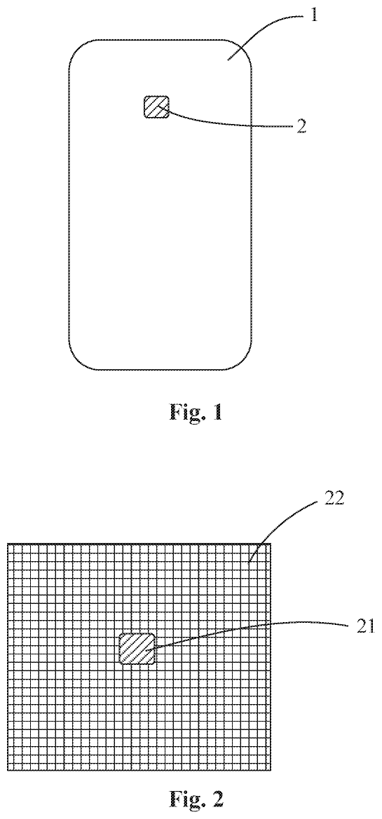

The present embodiment provides a terminal device. As shown in FIG. 1 and FIG. 2, the terminal device comprises a terminal device body 1. A processor is disposed in the terminal device body 1. A fingerprint module 21 and a touch screen 22 are disposed on the terminal device body 1. The touch screen 22 is disposed around the fingerprint module 21, and is configured to identify a user's touch operation. The fingerprint module 21 identifies user's fingerprint information, and the processor is configured to input a sliding direction of the fingerprint module 21 based on fingerprint information and touch information when the fingerprint information and the touch information are received, and execute an interaction operation corresponding to the sliding direction. Through disposing the touch screen 22 in a periphery of the fingerprint module 21 according to the present embodiment, the sliding direction input by the fingerprint module 21 can be identified without changing the fingerprint module 21.

As shown in FIG. 1 and FIG. 2, the fingerprint module 21 is located within the touch screen 22, and the touch screen 22 is disposed and extends along a circumferential direction of the fingerprint module 21 and forms a sensing region 2 together with the fingerprint module 21. The sensing region 2 comprises a fingerprint identification region formed by the fingerprint module 21 and a locus identification region formed by the touch screen 22. The sensing region 2 may be in a circle, in a square, or in some other shape. In practical applications, the sensing region 2 may be a front screen or a built-in screen.

In the present embodiment, the fingerprint module 21 is embedded in the touch screen 22, and there is no gap between them. In addition, the fingerprint module 21 and the touch screen 22 are connected to a central processor by using a unified interface, that is, the fingerprint module 21 and the touch screen 22 adopt a same connector to be connected to the central processor. That is to say, all signal lines of the fingerprint module 21 and all signal lines of the touch screen 22 are electrically connected to the connector. The connector is electrically connected to the central processor so that all signals output by the fingerprint module 21 and all signals output by the touch screen 22 interact with the central processor through the connector.

In addition to that, the processor is further configured to discard a touch signal when only receiving the touch information within a predetermined time. That is to say, after the processor detects the touch information generated by triggering the touch screen, the user's fingerprint information input by the fingerprint module 21 needs to be detected within the predetermined time, and the touch information is discarded when the fingerprint information is not received. In practical applications, the terminal device further comprises another touch screen. That is, the terminal device is disposed with two touch screens, which are respectively referred to as a fingerprint touch screen and a display touch screen. The fingerprint touch screen can be in a usable state only when the terminal device is in a screen lock state, and the sliding direction input by the fingerprint module 21 is identified through the fingerprint touch screen and the fingerprint module 21. The display touch screen is a touch screen disposed in a terminal device in the related art.

In one embodiment of the present application, the fingerprint module 21 and the touch screen 22 may adopt an in-display fingerprint identification module. The in-display fingerprint identification module comprises a touch screen and a fingerprint module integrated on the touch screen, and the touch screen covers the fingerprint module and has an area larger than a fingerprint identification area of the fingerprint module. Correspondingly, the touch screen comprises two parts. One part is a fingerprint identification region of the integrated fingerprint module, whereas another part is a locus identification region located in the periphery of the fingerprint module, and the fingerprint identification region and the locus identification region constitute a sensing region of the touch screen. In this manner, only the area of the touch screen of the in-display fingerprint identification module needs to be enlarged to achieve the objective of detecting the sliding direction input on the fingerprint module according to the present application.

### Embodiment 2

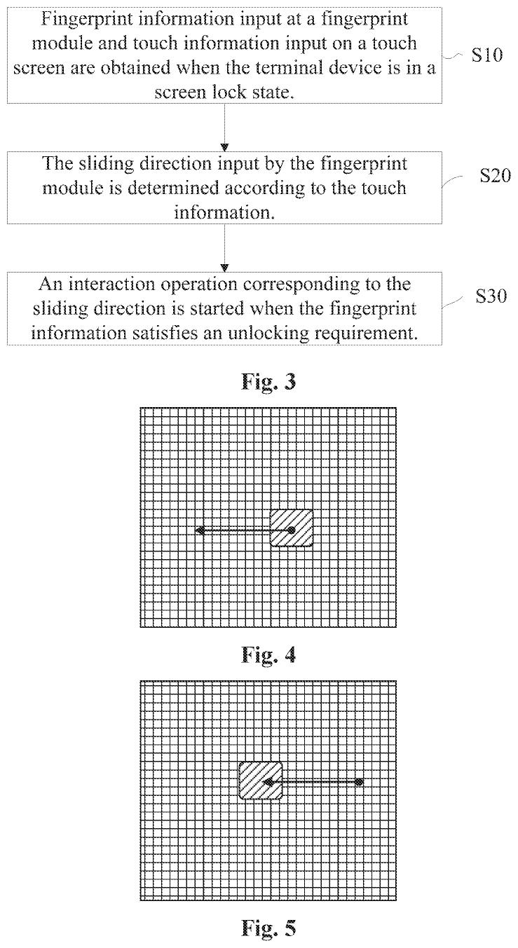

The present embodiment provides an interaction method of a terminal device applied to any of the above terminal devices. As shown in FIG. 3, the interaction method comprises:

S10: Fingerprint information input at a fingerprint module and touch information input on a touch screen are obtained when the terminal device is in a screen lock state.

In greater detail, the fingerprint information refers to user's fingerprint information collected through the fingerprint module. The touch information is touch information input through the touch screen. The touch information may be a touch locus formed by a sliding operation, and a plurality of touch points can be formed through tapping. Additionally, a time to obtain the fingerprint information and a collection time of the touch information are further recorded simultaneously when obtaining the fingerprint information and the touch information. The collection time of the touch information refers to a touch time of each of touch points included in the recorded touch information. In this manner, a touch point closest to the fingerprint information in terms of time can be determined based on the touch time corresponding to each of the touch points and a time corresponding to the fingerprint information, so that a sliding direction can be determined later based on positions of the touch point and a center point of the fingerprint module.

Exemplarily, in step S10, obtaining the fingerprint information input at the fingerprint module and the touch information input on the touch screen when the terminal device is in the screen lock state specifically comprises:

S11: The fingerprint information input at the fingerprint module and the touch information input on the touch screen are monitored when the terminal device is in the screen lock state.

S12: Whether a second type of control information is received or not within a predetermined time is detected after a first type of control information is monitored. The first type of control information is the fingerprint information/touch information. The second type of control information is the touch information/fingerprint information.

S13: A step of determining the sliding direction input by the fingerprint module is executed if the second type of control information is detected.

In greater detail, if another control information is detected within the predetermined time after detecting one control information, it is determined that the operation is a sliding operation input on the fingerprint module. Therefore, the sliding direction input by the fingerprint module can be obtained.

In one embodiment of the present application, in step S10, obtaining the fingerprint information input at the fingerprint module and the touch information input on the touch screen when the terminal device is in the screen lock state further comprises:

S14: If the second type of control information is not detected, a type of the first type of control information is determined. The first type of control information comprises the fingerprint information and the touch information.

S15: When the first type of control information is the fingerprint information, the terminal device is unlocked.

S16. When the first type of control information is the touch information, the touch information is discarded.

In greater detail, if the second type of control information is not detected, it indicates that the sliding direction is not input on the fingerprint module, thus further executing an operation corresponding to the first type of control information. When the first type of control information is the fingerprint information, it indicates that only unlocking the terminal device is needed so that the terminal device is unlocked. When the first type of control information is the touch information, the touch information is directly discarded without any operation.

S20: The sliding direction input by the fingerprint module is determined according to the touch information.

In greater detail, the sliding direction input by the fingerprint module refers to a direction of motion from the fingerprint module to the touch screen or a direction of motion from the touch screen to the fingerprint module, so that the sliding direction can be determined according to a connection line between a touch point closest to the fingerprint module in the touch information and the center point of the fingerprint module. The closest touch point refers to a collected touch point that is closest in time to a time point when the fingerprint information is collected. In practical applications, some other method may be adopted to determine the sliding direction. For example, a connection direction between a start point of the touch information and the center point of the fingerprint module, a connection direction between an end point of the touch information and the center point of the fingerprint module, etc., is adopted.

In step S20, determining the sliding direction input by the fingerprint module according to the touch information specifically comprises:

S21: The touch point closest to the fingerprint module in the touch information is obtained.

S22: The sliding direction input by the fingerprint module is determined according to a position relationship between the touch point and a center position of the fingerprint module.

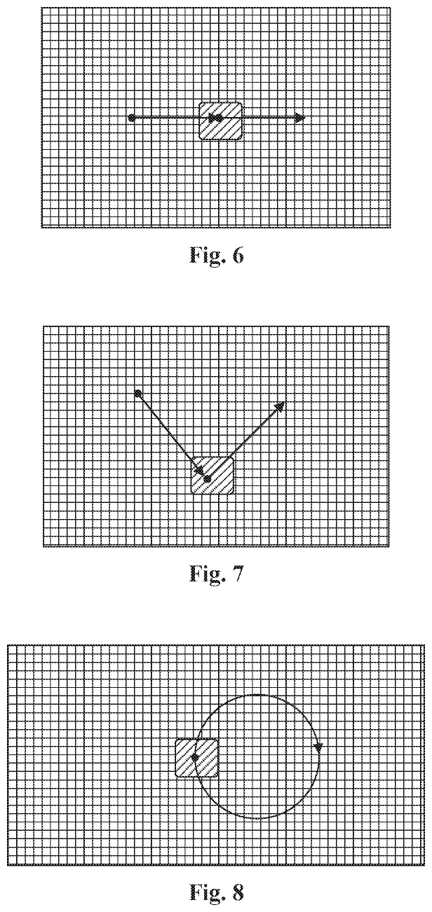

In greater detail, as shown in FIG. 4 to FIG. 5, a user's finger starts to identify a fingerprint at the fingerprint module (the fingerprint identification region)/identify a locus on the touch screen (the locus identification region), moves to the touch screen (the locus identification region)/the fingerprint module (the fingerprint identification region) to identify the locus/fingerprint, and touches a point/the center position of the fingerprint module to determine the sliding direction. In a modified embodiment of the present embodiment, as shown in FIG. 6 to FIG. 7, the finger is identified on the touch screen (the locus identification region) to identify that the locus departs and passes through the fingerprint module (the fingerprint identification region) so as to identify the fingerprint, and the locus finally returns to the touch screen (the locus identification region) to identify the locus. In another modified embodiment of the present embodiment, as shown in FIG. 8, the finger is identified at the fingerprint module (the fingerprint identification region) to identify that the fingerprint departs and passes through the touch screen (the locus identification region) so as to identify the locus, and the fingerprint finally returns to the fingerprint module (the fingerprint identification region).

S30: An interaction operation corresponding to the sliding direction is started when the fingerprint information satisfies an unlocking requirement.

A corresponding relationship between the sliding direction and the interaction operation is a predetermined setting. The interaction operation may be opening a main interface of an application (app), or may be opening a last used application, or opening a flashlight, a calculator, a camera or other frequently used apps, etc. In practical applications, the corresponding relationship between the sliding direction and the interaction operation may be swiping left (for example, tap the fingerprint button and move to the left) to open the last opened app, swiping up (tap the fingerprint button and then move up) to move so as to open WeChat (WhatsApp), swiping right (for example, tap the fingerprint button and move to the right) to open the camera, etc. The left side of the button is tapped on and then actions generated by three interaction methods that can be customized by a user are tapped on, such as opening the flashlight, opening the calculator, opening the camera, opening other frequently used apps, etc.

Exemplarily, before obtaining the fingerprint information input at the fingerprint module and the touch information input on the touch screen when the terminal device is in the screen lock state, the interaction method comprises:

S01: A database is established in advance to store the corresponding relationship between the sliding direction and the interaction operation. Sliding directions correspond to interaction operations one on one.

In greater detail, the database is disposed in the terminal device in advance. The corresponding relationship between the sliding direction and the interaction operation is disposed in the database. In this manner, after determining the sliding direction, its corresponding interaction operation can be determined according to the corresponding relationship, and the corresponding interaction operation is executed. Of course, the user also can define the corresponding relationship between the sliding direction and the interaction operation to improve the flexibility for use.

The present application further provides a storage medium. The storage medium stores a plurality of instructions. The instructions are adapted to be loaded and executed by a processor to perform any one of the above interaction methods of the terminal device.

In greater detail, logic instructions in the memory may be implemented in the form of a software functional unit and sold or used a stand-alone product, and may be stored in a computer-readable storage medium.

The memory, as a computer-readable storage medium, may be configured to store a software program or a computer-executable program, such as program instructions or modules corresponding to the methods in the embodiments of the present application. The processor runs the software program, the instructions or the modules stored in the memory to execute a functional application and data processing, that is, realizing the method in the foregoing embodiments.

The memory may comprise a storage program area and a storage data area. The storage program area may store an operating system and application programs required by at least one function. The storage data area may store data created according to the use of the terminal device, and the like. In addition, the memory may comprise a high-speed random access memory, and may comprise a non-volatile memory, for example, various media that can store program codes including a U disk, a mobile hard disk, a read-only memory (ROM), a random access memory (RAM), a magnetic disk or a compact disc, etc., or may be a transient storage medium.

Additionally, the plurality of instructions in the above storage medium are loaded and executed by the processor to perform the interaction method provided by the operations of:

obtaining fingerprint information input at a fingerprint module and touch information input on a touch screen when a terminal device is in a screen lock state, and recording an acquisition time of the fingerprint information and a collection time of the touch information;

determining a sliding direction input by the fingerprint module based on the touch information, the acquisition time of the fingerprint information and the collection time of the touch information; and

starting an interaction operation corresponding to the sliding direction when the fingerprint information satisfies an unlocking requirement.

According to the storage medium, obtaining the fingerprint information input at the fingerprint module and the touch information input on the touch screen when the terminal device is in the screen lock state comprises:

monitoring the fingerprint information input at the fingerprint module and the touch information input on the touch screen when the terminal device is in the screen lock state;

detecting whether a second type of control information is received or not within a predetermined time after a first type of control information is monitored, wherein the first type of control information is the fingerprint information/touch information, the second type of control information is the touch information/fingerprint information; and

executing an operation of determining the sliding direction input by the fingerprint module if the second type of control information is detected.

According to the storage medium, obtaining the fingerprint information input at the fingerprint module and the touch information input on the touch screen when the terminal device is in the screen lock state further comprises:

determining a type of the first type of control information if the second type of control information is not detected, wherein the first type of control information comprises the fingerprint information and the touch information;

unlocking the terminal device when the first type of control information is the fingerprint information; and

discarding the touch information when the first type of control information is the touch information.

According to the storage medium, the sliding direction is a direction from the touch screen to the fingerprint module or a direction from the fingerprint module to the touch screen.

According to the storage medium, before obtaining the fingerprint information input at the fingerprint module and the touch information input on the touch screen when the terminal device is in the screen lock state, the interaction method further comprises:

establishing a database in advance, the database being configured to store a corresponding relationship between the sliding direction and the interaction operation, wherein sliding directions correspond to interaction operations one on one.

According to the storage medium, the operation of determining the sliding direction input by the fingerprint module based on the touch information, the acquisition time of the fingerprint information and the collection time of the touch information comprises:

obtaining a touch point closest to the fingerprint module in the touch information based on the touch information, the acquisition time of the fingerprint information and the collection time of the touch information; and

determining the sliding direction input by the fingerprint module according to a position relationship between the touch point and a center position of the fingerprint module.

According to the storage medium, the collection time of the touch information refers to a touch time of each of touch points included in the recorded touch information, the operation of obtaining the touch point closest to the fingerprint module in the touch information based on the touch information, the acquisition time of the fingerprint information and the collection time of the touch information comprises:

determining the touch point closest to the fingerprint information in terms of time in the touch information based on the touch time corresponding to each of the touch points included in the touch information and the acquisition time corresponding to the fingerprint information.

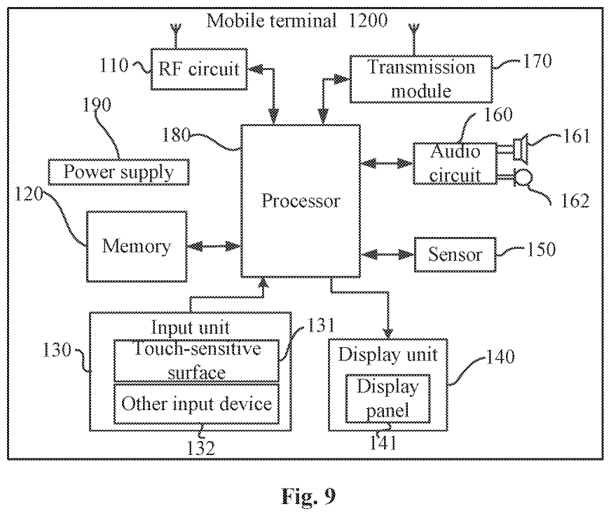

FIG. 9 is a schematic diagram of a structure of a mobile terminal according to one embodiment of the present application. The mobile terminal can be used to perform the interaction method of the terminal device according to the above embodiment. The mobile terminal 1200 may be a smart phone or a tablet computer.

As shown in FIG. 9, the mobile terminal 1200 may comprise components, such as a radio frequency (RF) circuit 110, a memory 120 including one or more (only one is shown in the figure) computer-readable storage media, an input unit 130, a display unit 140, a sensor 150, an audio circuit 160, a transmission module 170, a processor 180 including one or more (only one is shown in the figure) processing cores, and a power supply 190, etc. Those skilled in the art would understand that the mobile terminal 1200 is not limited to the structure of the mobile terminal 1200 shown in FIG. 9. The mobile terminal 1200 may comprise more or less components than those illustrated in the figure, or some components may be combined, or the mobile terminal 1200 may have different component arrangements.

The RF circuit 110 may be configured to receive and send a signal during an information receiving and sending process or a conversation process. Specifically, after receiving downlink information from a base station, the RF circuit 110 delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by wireless communication. The wireless communication may use any communications standard or protocol, which includes, but is not limited to, a Global System for Mobile communications (GSM), an Enhanced Data GSM Environment (EDGE), a Wideband Code Division Multiple Access (WCDMA), a Code Division Access (CDMA), a Time Division Multiple Access (TDMA), a Wireless Fidelity (Wi-Fi) such as IEEE 802.11a, IEEE 802.11b, IEEE802.11g and IEEE 802.11n, a Voice over Internet Protocol (VoIP), a Worldwide Interoperability for Microwave Access (Wi-Max), any other protocols for e-mail, instant communication and short message, and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program required by at least one function (such as a sound playback function and an image display function), and the like. The data storage area may store data (such as audio data and an address book) created according to use of the terminal 1200, and the like. In addition, the memory 120 may include a high speed random access memory, and may also include a non-volatile memory, such as at least one magnetic disk storage device, a flash memory device, or another volatile solid-state storage device. Correspondingly, the memory 120 may further include a memory controller, so that the processor 180 and the input unit 130 access the memory 120.

The input unit 130 may be configured to receive input digit or character information, and generate keyboard, mouse, joystick, optical, or track ball signal input related to the user setting and function control. Specifically, the input unit 130 may include a touch-sensitive surface 131 and other input device 132. The touch-sensitive surface 131 may also be referred to as a touch screen or a touch panel, and may collect a touch operation of a user on or near the touch-sensitive surface (such as an operation of a user on or near the touch-sensitive surface 131 by using any suitable object or attachment, such as a finger or a stylus), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be implemented by using various types, such as a resistive type, a capacitance type, an infrared type, and a surface sound wave type. In addition to the touch-sensitive surface 131, the input unit 130 may further include the another input device 132. Specifically, the another input device 132 may include, but is not limited to, one or more of a physical keyboard, a functional key (such as a volume control key or a switch key), a track ball, a mouse, and a joystick.

The display unit 140 may be configured to display information input by the user or information provided for the user, and various graphical user ports of the terminal 1200. The graphical user ports may be formed by a graph, a text, an icon, a video, and any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine a type of a touch event. Then, the processor 180 provides corresponding visual output on the display panel 141 according to the type of the touch event. Although, in FIG. 3, the touch-sensitive surface 131 and the display panel 141 are used as two separate parts to implement input and output functions, in some embodiments, the touch-sensitive surface 131 and the display panel 141 may be integrated to implement the input and output functions.

The terminal 1200 may further include at least one sensor 150, such as an optical sensor, a motion sensor, and other sensors. Specifically, the optical sensor may include an ambient light sensor and a proximity sensor. The ambient light sensor may adjust luminance of the display panel 141 according to brightness of the ambient light. The proximity sensor may switch off the display panel 141 and/or backlight when the terminal 1200 is moved to the ear. As one type of motion sensor, a gravity acceleration sensor may detect magnitude of accelerations at various directions (which generally are triaxial), may detect magnitude and a direction of the gravity when static, and may be configured to identify an application of a mobile phone attitude (such as switching between horizontal and vertical screens, a related game, and attitude calibration of a magnetometer), a related function of vibration identification (such as a pedometer and a knock). Other sensors, such as a gyroscope, a barometer, a hygrometer, a thermometer, and an infrared sensor, which may be configured in the terminal 1200 are not further described herein.

The audio circuit 160, a loudspeaker 161, and a microphone 162 may provide audio interfaces between the user and the terminal 1200. The audio circuit 160 may transmit, to the loudspeaker 161, a received electric signal converted from received audio data. The loudspeaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RF circuit 110, or outputs the audio data to the memory 120 for further processing. The audio circuit 160 may further include an earplug jack, so as to provide communication between a peripheral earphone and the terminal 1200.

The terminal 1200 may help, by using the transmission module 170 (e.g. Wi-Fi module), a user to receive and send an e-mail, browse a webpage, and access stream media, and the like, which provides wireless broadband Internet access for the user. Although FIG. 3 shows the transmission module 170, it may be understood that, the wireless communications unit is not a necessary component of the terminal 1200, and can be ignored according to demands without changing the scope of the essence of the present disclosure.

The processor 180 is a control center of the terminal 1200, and connects various parts of the terminal by using various interfaces and lines. By running or executing the software program and/or module stored in the memory 120, and invoking data stored in the memory 120, the processor 180 performs various functions and data processing of the terminal 1200, thereby performing overall monitoring on the mobile phone. Optionally, the processor 180 may include one or more processing cores. Preferably, the processor 180 may integrate an application processor and a modem. The application processor mainly processes an operating system, a user interface, an application program, and the like. The modem mainly processes wireless communication. It may be understood that, the foregoing modem may not be integrated into the processor 180.

The terminal 1200 further includes the power supply 190 (such as a battery) for supplying power to the components. Preferably, the power supply may be logically connected to the processor 180 by using a power supply management system, thereby implementing functions, such as charging, discharging, and power consumption management, by using the power supply management system. The power supply 190 may further include any component, such as one or more direct current or alternate current power supplies, a re-charging system, a power supply fault detection circuit, a power supply converter or an inverter, and a power supply state indicator.

The mobile terminal 1200 may further comprise a camera (such as a front camera, a rear camera), a Bluetooth module, and the like, and a description in this regard is not provided. In greater detail, a display unit of the mobile terminal is a touch screen display according to the present embodiment. The mobile terminal further comprises a memory and one or more programs. The one or one or more programs are stored in the memory, and are configured to be executed by one or more processors to perform the operations of:

obtaining fingerprint information input at a fingerprint module and touch information input on a touch screen when a terminal device is in a screen lock state, and recording an acquisition time of the fingerprint information and a collection time of the touch information;

determining a sliding direction input by the fingerprint module based on the touch information, the acquisition time of the fingerprint information and the collection time of the touch information; and

starting an interaction operation corresponding to the sliding direction when the fingerprint information satisfies an unlocking requirement.

In some embodiments, obtaining the fingerprint information input at the fingerprint module and the touch information input on the touch screen when the terminal device is in the screen lock state comprises:

monitoring the fingerprint information input at the fingerprint module and the touch information input on the touch screen when the terminal device is in the screen lock state;

detecting whether a second type of control information is received or not within a predetermined time after a first type of control information is monitored, wherein the first type of control information is the fingerprint information/touch information, the second type of control information is the touch information/fingerprint information; and

executing an operation of determining the sliding direction input by the fingerprint module if the second type of control information is detected.

In some embodiments, obtaining the fingerprint information input at the fingerprint module and the touch information input on the touch screen when the terminal device is in the screen lock state further comprises:

determining a type of the first type of control information if the second type of control information is not detected, wherein the first type of control information comprises the fingerprint information and the touch information;

unlocking the terminal device when the first type of control information is the fingerprint information; and

discarding the touch information when the first type of control information is the touch information.

In some embodiments, the sliding direction is a direction from the touch screen to the fingerprint module or a direction from the fingerprint module to the touch screen.

In some embodiments, before obtaining the fingerprint information input at the fingerprint module and the touch information input on the touch screen when the terminal device is in the screen lock state, the interaction method further comprises:

establishing a database in advance, the database being configured to store a corresponding relationship between the sliding direction and the interaction operation, wherein sliding directions correspond to interaction operations one on one.

In some embodiments, the operation of determining the sliding direction input by the fingerprint module based on the touch information, the acquisition time of the fingerprint information and the collection time of the touch information comprises:

obtaining a touch point closest to the fingerprint module in the touch information based on the touch information, the acquisition time of the fingerprint information and the collection time of the touch information; and

determining the sliding direction input by the fingerprint module according to a position relationship between the touch point and a center position of the fingerprint module.

In some embodiments, the collection time of the touch information refers to a touch time of each of touch points included in the recorded touch information, the operation of obtaining the touch point closest to the fingerprint module in the touch information based on the touch information, the acquisition time of the fingerprint information and the collection time of the touch information comprises:

determining the touch point closest to the fingerprint information in terms of time in the touch information based on the touch time corresponding to each of the touch points included in the touch information and the acquisition time corresponding to the fingerprint information.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A terminal device comprising a processor, a fingerprint module and a touch screen disposed around the fingerprint module, the fingerprint module being configured to identify user's fingerprint information, the touch screen being configured to identify user's touch information, the processor being configured to determine a sliding direction input to the fingerprint module based on fingerprint information and touch information when the fingerprint information and the touch information are received, and execute an interaction operation corresponding to the sliding direction.

2. The terminal device as claimed in claim 1, wherein the processor is further configured to discard the touch information when only receiving the touch information within a predetermined time.

3. The terminal device as claimed in claim 1, wherein the fingerprint module is embedded in the touch screen to form an integrated structure, the touch screen is disposed and extends along a circumferential direction of the fingerprint module.

4. The terminal device as claimed in claim 3, wherein the fingerprint module and the touch screen adopt a same connector to be connected to the processor, so that all signals output by the fingerprint module and all signals output by the touch screen interact with the processor through the same connector.

5. The terminal device as claimed in claim 1, wherein the touch screen comprises a fingerprint touch screen and a display touch screen;
the fingerprint touch screen being configured to cooperate with the fingerprint module to identify the sliding direction input by the fingerprint module, wherein the fingerprint touch screen is in a usable state only when the terminal device is in a screen lock state;
the display touch screen being configured for touch input and image display.

6. The terminal device as claimed in claim 1, wherein the fingerprint module is integrated on the touch screen, the touch screen covers the fingerprint module, and the touch screen has an area larger than a fingerprint identification area of the fingerprint module.

7. The terminal device as claimed in claim 6, wherein the touch screen comprises integrating a fingerprint identification region of the fingerprint module and a locus identification region in a periphery of the fingerprint module, the fingerprint identification region and the locus identification region constitute a sensing region of the touch screen.

8. An interaction method of a terminal device applied to the terminal device, the terminal device comprising a processor, a fingerprint module and a touch screen disposed around the fingerprint module, the fingerprint module being configured to identify user's fingerprint information, the touch screen being configured to identify user's touch information, the processor being configured to determine a sliding direction input to the fingerprint module based on fingerprint information and touch information when the fingerprint information and the touch information are received, and execute an interaction operation corresponding to the sliding direction, the interaction method comprising:
obtaining the fingerprint information input at the fingerprint module and the touch information input on the touch screen when the terminal device is in a screen lock state;
determining the sliding direction input by the fingerprint module according to the touch information; and
starting the interaction operation corresponding to the sliding direction when the fingerprint information satisfies an unlocking requirement.

9. The interaction method as claimed in claim 8, wherein obtaining the fingerprint information input at the fingerprint module and the touch information input on the touch screen when the terminal device is in the screen lock state comprises:
monitoring the fingerprint information input at the fingerprint module and the touch information input on the touch screen when the terminal device is in the screen lock state;
detecting whether a second type of control information is received or not within a predetermined time after a first type of control information is monitored, wherein the first type of control information is the fingerprint information/touch information, the second type of control information is the touch information/fingerprint information; and
executing a step of determining the sliding direction input by the fingerprint module if the second type of control information is detected.

10. The interaction method as claimed in claim 9, wherein obtaining the fingerprint information input at the fingerprint module and the touch information input on the touch screen when the terminal device is in the screen lock state further comprises:
determining a type of the first type of control information if the second type of control information is not detected, wherein the first type of control information comprises the fingerprint information and the touch information;
unlocking the terminal device when the first type of control information is the fingerprint information; and
discarding the touch information when the first type of control information is the touch information.

11. The interaction method as claimed in claim 8, wherein the sliding direction is a direction from the touch screen to the fingerprint module or a direction from the fingerprint module to the touch screen.

12. The interaction method as claimed in claim 8, wherein before obtaining the fingerprint information input at the fingerprint module and the touch information input on the touch screen when the terminal device is in the screen lock state, the interaction method further comprises:
establishing a database in advance, the database being configured to store a corresponding relationship between the sliding direction and the interaction operation, wherein sliding directions correspond to interaction operations one on one.

13. The interaction method as claimed in claim 8, wherein determining the sliding direction input by the fingerprint module according to the touch information comprises:
obtaining a touch point closest to the fingerprint module in the touch information; and
determining the sliding direction input by the fingerprint module according to a position relationship between the touch point and a center position of the fingerprint module.

14. A storage medium storing a plurality of instructions, the instructions being adapted to be loaded and executed by a processor to execute the following operations:
obtaining fingerprint information input at a fingerprint module and touch information input on a touch screen when a terminal device is in a screen lock state, and recording an acquisition time of the fingerprint information and a collection time of the touch information;
determining a sliding direction input by the fingerprint module based on the touch information, the acquisition time of the fingerprint information and the collection time of the touch information; and
starting an interaction operation corresponding to the sliding direction when the fingerprint information satisfies an unlocking requirement.

15. The storage medium as claimed in claim 14, wherein obtaining the fingerprint information input at the fingerprint module and the touch information input on the touch screen when the terminal device is in the screen lock state comprises:
monitoring the fingerprint information input at the fingerprint module and the touch information input on the touch screen when the terminal device is in the screen lock state;
detecting whether a second type of control information is received or not within a predetermined time after a first type of control information is monitored, wherein the first type of control information is the fingerprint information/touch information, the second type of control information is the touch information/fingerprint information; and
executing an operation of determining the sliding direction input by the fingerprint module if the second type of control information is detected.

16. The storage medium as claimed in claim 15, wherein obtaining the fingerprint information input at the fingerprint module and the touch information input on the touch screen when the terminal device is in the screen lock state further comprises:
determining a type of the first type of control information if the second type of control information is not detected, wherein the first type of control information comprises the fingerprint information and the touch information;
unlocking the terminal device when the first type of control information is the fingerprint information; and
discarding the touch information when the first type of control information is the touch information.

17. The storage medium as claimed in claim 14, wherein the sliding direction is a direction from the touch screen to the fingerprint module or a direction from the fingerprint module to the touch screen.

18. The storage medium as claimed in claim 14, wherein before obtaining the fingerprint information input at the fingerprint module and the touch information input on the touch screen when the terminal device is in the screen lock state, the interaction method further comprises:
establishing a database in advance, the database being configured to store a corresponding relationship between the sliding direction and the interaction operation, wherein sliding directions correspond to interaction operations one on one.

19. The storage medium as claimed in claim 14, wherein the operation of determining the sliding direction input by the fingerprint module based on the touch information, the acquisition time of the fingerprint information and the collection time of the touch information comprises:
obtaining a touch point closest to the fingerprint module in the touch information based on the touch information, the acquisition time of the fingerprint information and the collection time of the touch information; and
determining the sliding direction input by the fingerprint module according to a position relationship between the touch point and a center position of the fingerprint module.

20. The storage medium as claimed in claim 19, wherein the collection time of the touch information refers to a touch time of each of touch points included in the recorded touch information, the operation of obtaining the touch point closest to the fingerprint module in the touch information based on the touch information, the acquisition time of the fingerprint information and the collection time of the touch information comprises:
determining the touch point closest to the fingerprint information in terms of time in the touch information based on the touch time corresponding to each of the touch points included in the touch information and the acquisition time corresponding to the fingerprint information.
